(19) United States
(12) Patent Application Publication
(10) Pub. No.: US 2012/0060317 A1
(43) Pub. Date: Mar. 15, 2012

(54) SCRAPER

(76) Inventor: Hubert Bischof, Murzzuschlag (AT)

(21) Appl. No.: 13/249,797

(22) Filed: Sep. 30, 2011

Related U.S. Application Data
(63) Continuation-in-part of application No. 12/938,473, filed on Nov. 3, 2010, now abandoned.
Application No. 12/938,473 is a continuation of application No. PCT/EP2009/054803, filed on Apr. 22, 2009.

(30) Foreign Application Priority Data
May 6, 2008 (DE) 10 2008 001574.1

(51) Int. Cl. B08B 1/00

(52) U.S. Cl. 15/256.5

(57) ABSTRACT

A scraper for scraping and/or cleaning, for example for scraping and/or cleaning of units for the production and/or treatment of a fibrous material web, such as scraping and/or cleaning of drying cylinders. The scraper includes a composite material including a resin matrix material, a plurality of fibers embedded in the resin matrix material, and copper and/or at least one copper alloy embedded in the resin matrix material. At least a portion of the resin matrix material is replaced with a silicone modified epoxy resin.

### CROSS REFERENCE TO RELATED APPLICATIONS

This is a continuation in part of U.S. patent application Ser. No. 12/938,473 filed on Nov. 3, 2010, which is incorporated herein by reference. U.S. patent application Ser. No. 12/938,473 is a continuation of PCT application No. PCT/EP2009/054803, entitled “SCRAPER”, filed Apr. 22, 2009, which is incorporated herein by reference.

### BACKGROUND OF THE INVENTION

1. Field of the Invention

The present invention relates to a scraper for scraping and/or cleaning, especially for scraping and/or cleaning of units in the production and/or treatment of a fibrous material web and preferably for scraping and/or cleaning of drying cylinders.

2. Description of the Related Art

Composite fiber scrapers consisting of glass and/or carbon composite materials are primarily used for scraping and/or cleaning of drying cylinders. The main focus is hereby directed to the useful service life and the cleaning efficiency of the scraper. However, a relatively high coefficient of friction is characteristic for this material combination. Such a relatively high coefficient of friction produces as a consequence a high frictional power which is required for the scraper. The drives for the respective units to which the scraper is allocated must also be sufficiently sized. Electrical consumption of these drives is also relatively high.

What is needed in the art is an improved scraper which offers a reduced coefficient of friction.

### SUMMARY OF THE INVENTION

The present invention provides a scraper for scraping and/or cleaning associated with scraping units and/or cleaning units for the production and treatment of a fibrous material web. The scraper is formed of a composite material including a resin matrix material having fibers embedded the resin matrix material, copper and/or at least one copper alloy embedded in the resin matrix material. At least a portion of the resin matrix material is replaced with a silicone modified epoxy resin.

A second embodiment of the present invention provides a scraper for scraping and/or cleaning associated with scraping units and/or cleaning units for the production and/or treatment of a fibrous material web. The scraper is formed from a composite material including a resin matrix material, fibers embedded in the resin matrix material and at least one of graphite, molybdenum disulfide (MoS₂) and hexagonal boron nitride embedded in the resin matrix material. At least a portion of the resin matrix material may be replaced with a silicone modified epoxy resin.

A third embodiment of the scraper according to the present invention is formed from a composite material including a resin matrix material, fibers embedded in the resin matrix material and copper and/or at least one copper alloy embedded in the resin matrix material. At least a portion of the resin matrix material is replaced with a silicone modified epoxy resin such that the copper and/or copper alloy, the silicone modified epoxy resin and the fibers coact to provide a reduced coefficient of friction of the composite material.

### DETAILED DESCRIPTION OF THE INVENTION

Scrapers, such as, for example, doctor blades working in a dryer section of a papermaking machine, are subject to high abrasion resulting from microvibrations. These microvibrations arise due to the material properties of carbon fibers which have a low internal damping and, thus, tend to vibrate in the working frame of the blades due to the stimulation of eigenfrequencies. As a result of these generated microvibrations, the carbon fibers are subject to breakage, which in turn weakens the epoxy matrix into which they are embedded. Eventually, the extent of carbon fiber breakage and weakening of the epoxy matrix reaches a point where the scraper begins to break down into substantially coarse debris. Due to the degree of coarseness of the debris, the breakdown of the scraper accelerates and successively bigger portions of the carbon and epoxy matrix begin to break away, resulting in quick and heavy abrasion of the blade.

The present invention provides a scraper having a reduced coefficient of friction that contains a matrix material, for example epoxy resin, into which copper and/or at least one copper alloy are mixed, and/or which is substituted at least partially by silicone modified epoxy. The coefficient of friction of the scraper is reduced on the basis of these characteristics. Through this reduction in the coefficient of friction the required frictional power for the scraper in the respective unit, for example in the dryer group, can be reduced, thereby being able to reduce the sizing and the electrical consumption of the drives for the respective unit.

The copper, or the at least one copper alloy respectively, is, for example, added into the resin matrix material in the form of powder or flakes. Further, at least one fibrous material, for example in the form of glass and/or carbon fibers, may be added into the matrix material. The matrix material is, for example, epoxy resin which meets the desired requirements in regard to elasticity and durability for applications of this type.

According to an additional embodiment of the scraper according to the present invention, alternatively to the copper and/or copper alloy, the matrix material may include, for example, graphite, molybdenum disulfide (MoS₂) or hexagonal boron nitride (BN), which may also be added into the matrix in the form of a powder or a plurality of flakes.

Scrapers according to the present invention having a reduced coefficient of friction can hereby be produced. Due to the reduction in the coefficient of friction the required frictional power for the unit in which the scraper is to be installed—for example the dryer group—can be reduced, thereby reducing the sizing and the electrical consumption of the drives for the unit.

The reduction in the coefficient of friction is achieved, for example, by addition of copper and/or at least one copper alloy in the form of powders or flakes into the resin matrix. Suitable fibrous materials are, for example, glass and/or carbon fibers.

An additional possibility to reduce the coefficient of friction exists in the substitution of parts of the epoxy resin matrix through silicone modified epoxy resin.

What is claimed is:

1. A scraper for at least one of scraping and cleaning associated with at least one of scraping units and cleaning units for at least one of the production and treatment of a fibrous material web, said scraper comprising:
a composite material including a resin matrix material, a plurality of fibers embedded in said resin matrix material, and copper and/or at least one copper alloy embedded in said resin matrix material, at least a portion of said resin matrix material being replaced with a silicone modified epoxy resin.

2. The scraper according to claim 1, wherein said scraper is for at least one of scraping and cleaning a plurality of drying cylinders.

3. The scraper according to claim 1, wherein said at least one of copper and said at least one copper alloy is in the form of one of a powder or a plurality of flakes added into said resin matrix material.

4. The scraper according to claim 1, wherein said plurality of fibers are in the form of at least one of glass and carbon fibers.

5. The scraper according to claim 1, wherein said resin matrix material includes an epoxy resin.

6. The scraper according to claim 1 wherein said plurality of fibers are in the form of glass and carbon fibers.

7. A scraper for at least one of scraping and cleaning associated with at least one of scraping units and cleaning units for at least one of the production and treatment of a fibrous material web, said scraper comprising:
a composite material including a resin matrix material, a plurality of fibers embedded in said resin matrix material, and at least one of graphite, molybdenum disulfide (MoS₂) and hexagonal boron nitride embedded in said resin matrix material, at least a portion of said resin matrix material being replaced with a silicone modified epoxy resin.

8. The scraper according to claim 7, wherein said scraper is a doctor blade.

9. The scraper according to claim 7, wherein said scraper is for at least one of scraping and cleaning a plurality of drying cylinders.

10. The scraper according to claim 7, wherein said at least one of graphite, molybdenum disulfide and hexagonal boron nitride are in the form of one of a powder and a plurality of flakes added into to said resin matrix material.

11. The scraper according to claim 7, wherein said resin matrix material is an epoxy resin matrix material.

12. The scraper according to claim 7, wherein said plurality of fibers are in the form of at least one of glass and carbon fibers.

13. The scraper according to claim 12, wherein said plurality of fibers are in the form of glass and carbon fibers.

14. A scraper for at least one of scraping and cleaning associated with at least one of scraping units and cleaning units for at least one of the production and treatment of a fibrous material web, said scraper comprising:
a composite material including a resin matrix material, a plurality of fibers embedded in said resin matrix material, and copper and/or at least one copper alloy embedded in said resin matrix material, at least a portion of said resin matrix material being replaced with a silicone modified epoxy resin, said copper and/or said at least one copper alloy, said silicone modified epoxy resin and said plurality of fibers coacting to provide a reduced coefficient of friction of said composite material.
